(19) United States
(12) Patent Application Publication
(10) Pub. No.: US 2013/0201008 A1
(43) Pub. Date: Aug. 8, 2013

(54) RFID TAG AND METHOD FOR SEARCHING FOR ARTICLES

(71) Applicants: Hsin-Pei CHANG, New Taipei (TW); Zong-Yuan SUN, New Taipei (TW); Da-Hua XIAO, Shenzhen (CN)

(72) Inventors: Hsin-Pei CHANG, New Taipei (TW); Zong-Yuan SUN, New Taipei (TW); Da-Hua XIAO, Shenzhen (CN)

(21) Appl. No.: 13/680,060

(22) Filed: Nov. 18, 2012

(30) Foreign Application Priority Data
Feb. 6, 2012 (CN) 201210025113.8

(51) Int. Cl. G06K 19/07

(52) U.S. Cl. CPC G06K 19/0723
USPC 340/10.42

(57) ABSTRACT

A radio frequency identification (RFID) tag includes a data receiving microchip, a radio frequency (RF) circuit, a microcontroller and an indication circuit. The data receiving microchip receives an identification code from an RFID reader. The radio frequency (RF) circuit receives an inquiry command from the RFID reader. The microcontroller electronically connects the data receiving microchip, the RF circuit, and the indication circuit. If the inquiry command is identical with the identification code or a predetermined part of the identification code, the microcontroller turns on the indication circuit.

### BACKGROUND

1. Technical Field

The disclosure generally relates to radio frequency identification (RFID) tags, and particularly relates to a RFID tag and method for searching for articles.

2. Description of the Related Art

Searching and tracking of articles have evolved in transportation business through the use of RFID tags. The RFID tags can be attached to the articles and be searched for according to an express serial number. However, it may be inconvenient for couriers to have to search for the articles one at a time because the couriers must make sure each article corresponds to the express serial number.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present embodiments.

FIG. 1 is an assembled view of a RFID tag, according to an exemplary embodiment.

FIG. 2 is a block diagram of the RFID tag as shown in FIG. 1.

FIG. 3 is a flowchart illustrating a method for searching for articles via the RFID tag in FIG. 2, according to an exemplary embodiment.

FIG. 4 is a flowchart illustrating a method for obtaining identification code of the method for searching for the articles as shown in FIG. 3.

### DETAILED DESCRIPTION

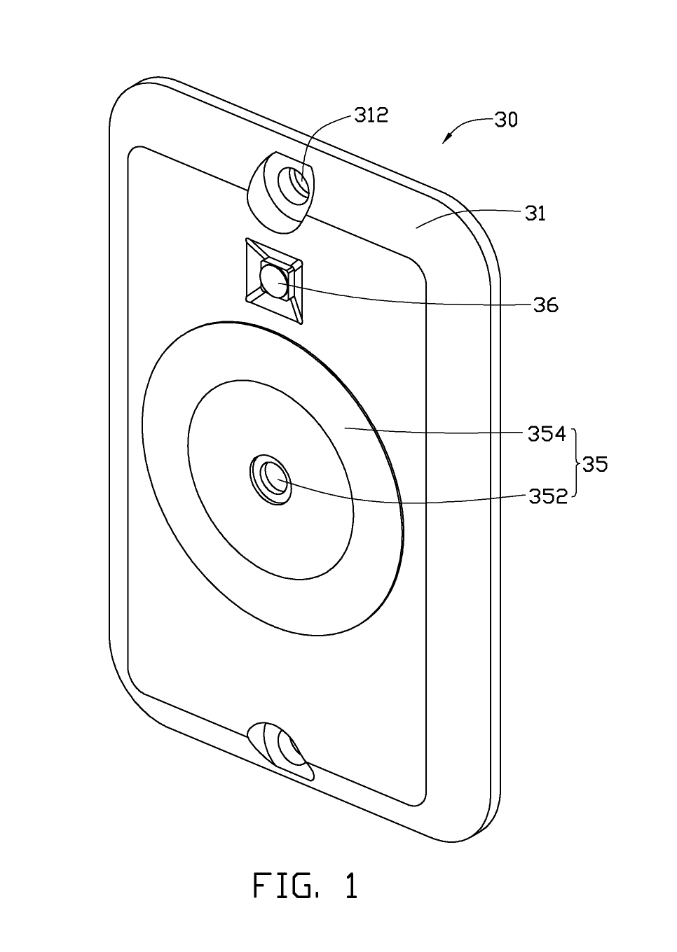

FIG. 1 is an assembled view of an RFID tag 30, according to an exemplary embodiment. The RFID tag 30 can be placed in or on articles, and can be searched for during transportation and storing processes of the articles. The articles can be clothes, computers, or confidential files, for example, and each article is allocated an express serial number by express company, and transported to a predetermined destination. For example, one article with express serial number “XXXX” can be transported to Washington, and another article with express serial number “XXYY” can be transported to New York. Thus, each express serial number corresponds to a predetermined destination.

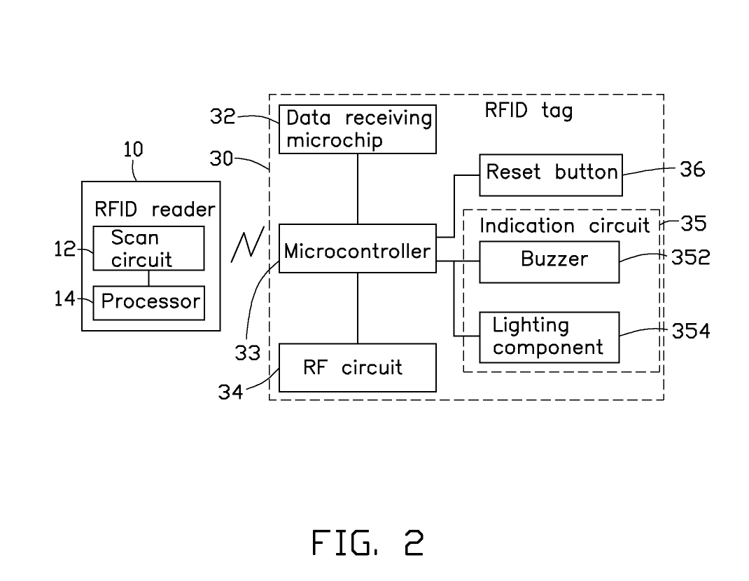

In FIG. 2, the RFID tag 30 communicates with a RFID reader 10. The RFID reader 10 obtains the express serial number from the article, and generates an identification code according to the express serial number. Specifically, the RFID reader 10 includes a scan circuit 12 and a processor 14 electronically connected to the scan circuit 12. The scan circuit 12 scans and obtains the express serial number of the article, and transmits the express serial number to the processor 14. The processor 14 generates an identification code according to the express serial number. For example, if the article is to be transported to Washington, the processor 14 generates a first identification code, and the last two numbers of the first identification code may be “01”. If the article is to be transported to New York, the processor 14 generates a second identification code, and the last two numbers of the second identification code may be “02”. Additionally, the RFID reader 10 sends the identification code to the RFID tag 30.

Moreover, the RFID reader 10 sends an inquiry command to the RFID tag 30 in relation to one or more articles. The inquiry command can be the identification code or can just be the last two numbers of the identification code. Thus, in the above example, the RFID reader 10 can send an inquiry command “XX01” to inquire which one of the articles is to be transported to Washington, and the RFID reader 10 can also send an inquiry command “02” to inquire about which of the articles will be transported to New York.

The RFID tag 30 includes a body 31, a data receiving microchip 32, a microcontroller 33, a radio frequency (RF) circuit 34, an indication circuit 35, and a reset button 36. The signal receiving circuit 32, the microcontroller 33, the radio frequency (RF) circuit 34, the indication circuit 35, and the reset button 36 are all integrated on the body 31.

In one exemplary embodiment, the data receiving microchip 32 is an electrically erasable programmable read-only memory (EEPROM) including a radio frequency (RF) port 322 and an inter-integrated circuit (I2C) port 324. The RF port 322 receives the identification code from the RFID tag 30, and the identification code can be stored in the data receiving microchip 32. The microcontroller 33 is electronically connected between the I2C port 324 and the RF circuit 34, to read the identification code from the data receiving microchip 32 and transmitting the identification code to the RF circuit 34.

The RF circuit 34 feeds the identification code to the RFID reader 10, and receives an acknowledgement (ACK) command from the RFID reader 10. Thus, the RF circuit 34 can communicate with the RFID reader 10 to receive the inquiry command.

Additionally, the microcontroller 33 determines whether the inquiry command is identical with the identification code or a predetermined part of the identification code (e.g., last two numbers of the identification code), and turns on the indication circuit 35 if the inquiry command is identical with the identification code or the predetermined part of the identification code. If the inquiry command is not identical with the identification code or the predetermined part of the identification code, the microcontroller 32 controls the RFID tag 30 to enter into a sleep state to conserve power. In one exemplary embodiment, the time period of the sleep state is about five seconds, in this time period, the RFID reader 10 continues to communicate with other RFID tags.

In one exemplary embodiment, the indication circuit 35 includes a buzzer 352 and a lighting component 354 both electronically connected to the microcontroller 33. When the RFID tag 30 accepts the inquiry by the RFID reader 10, the buzzer 352 and the lighting component 354 are turned on by the microcontroller 33 (e.g., emit a noise or light). Thus, the couriers can immediately search for the articles. In other exemplary embodiment, one of the buzzer 352 and the lighting component 354 can be omitted.

The reset button 36 is electronically connected to the microcontroller 33, the reset button 36 generates a command the when the reset button 36 is actuated, and the microcontroller 33 receives the command to power off the RFID tag 30.

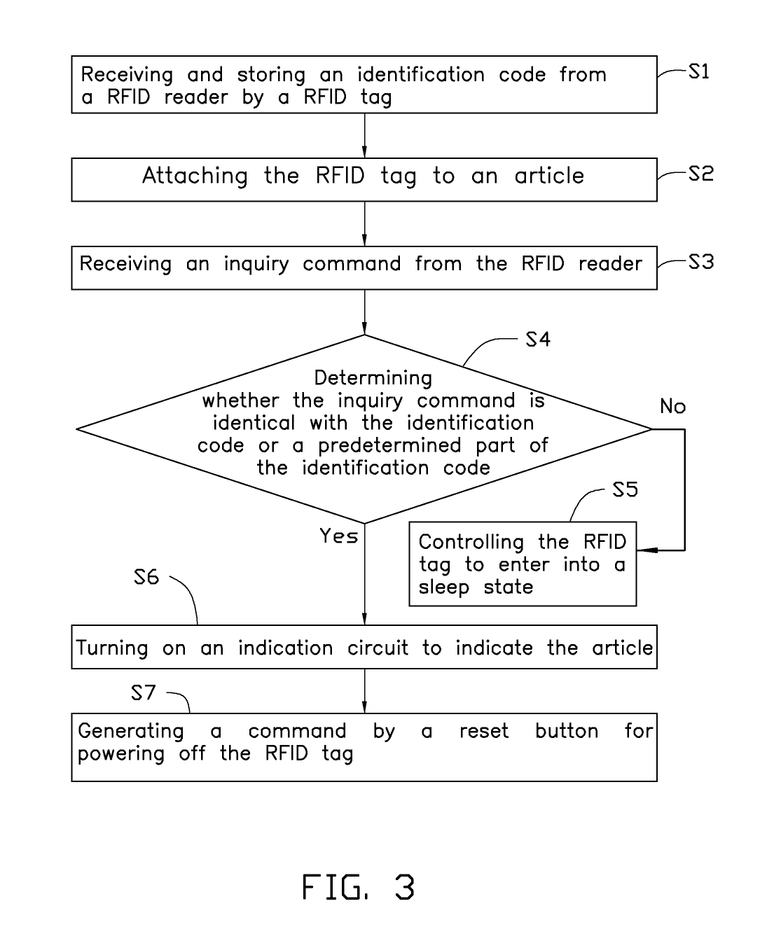

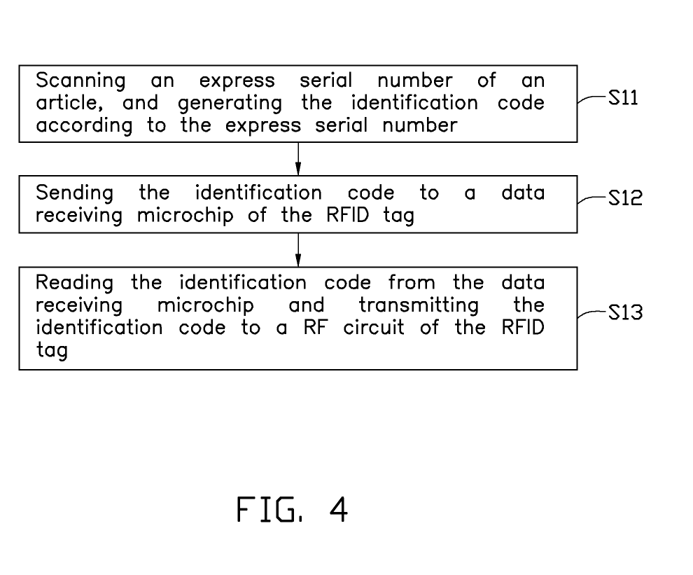

FIGS. 3-4 are flowcharts of one embodiment of a method for searching for the article. Depending on the embodiment, additional blocks may be added, others removed, and the ordering of the blocks may be changed. The method for searching for the articles may include the following steps.

In step S1, the RFID tag 30 receives and stores the identification code of the article. The step S1 may further include the following sub-steps.

In sub-step S11, the RFID reader 10 scans the express serial number of the article, and generates the identification code according to the express serial number.

In sub-step S12, the RFID reader 10 sends the identification code to the data receiving microchip 32.

In sub-step S13, the microcontroller 33 reads the identification code from the data receiving microchip 32 and transmits the identification code to the RF circuit 34.

In step S2, the RFID tag 30 is attached to the article, and the article may be positioned in a depository such as a warehouse.

In step S3, when the RFID reader 10 searches for the article, the RF circuit 34 feeds the identification code to the RFID reader 10, and receives the ACK command from the RFID reader 10, and then the RF circuit 34 is in communication with the RFID reader 10 to receive the inquiry command from the RFID reader 10.

In step S4, the microcontroller 33 determines whether the inquiry command is identical with the identification code or the predetermined part of the identification code. If the inquiry command is not identical with the identification code or the predetermined part of the identification code, step S5 is implemented. If the inquiry command is identical with the identification code, step S6 is implemented.

In step S5, the microcontroller 33 controls the RFID tag 30 to enter into the sleep state.

In step S6, the microcontroller 33 turns on the buzzer 352 and the lighting component 354 to identify the article which is searched by the RFID reader 10.

In step S7, the reset button 36 generates a command when the reset button 36 is actuated, and then the RFID tag 30 is powered off.

In summary, the RFID tag 30 can respond to an RF reader 10 after comparing the identification code and the inquiry command, and turns on the indication circuit 35 if the inquiry command is identical with the identification code or the predetermined part of the identification code. Thus, the couriers can search for and immediately establish the presence of the relevant articles. Additionally, the couriers can search for all articles which have a common destination, this is very convenient for couriers in managing the articles.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in the matters of shape, size, and arrangement of parts within the principles of the exemplary disclosure to the full extent indicated by the broad general meaning of the terms in which the appended claims are expressed.

What is claimed is:

1. A radio frequency identification (RFID) tag for an article and in electronic communication with an RFID reader, comprising:
a data receiving microchip receiving an identification code from the RFID reader;
a radio frequency (RF) circuit receiving an inquiry command from the RFID reader;
a microcontroller electronically connected between the data receiving microchip and the RF circuit; and
an indication circuit electronically connected to the microcontroller;
wherein the microcontroller determines whether the inquiry command is identical with the identification code or a predetermined part of the identification code, and turns on the indication circuit if the inquiry command is identical with the identification code or the predetermined part of the identification code.

2. The RFID tag as claimed in claim 1, wherein if the inquiry command is not identical with the identification code or the predetermined part of the identification code, the microcontroller controls the RFID tag to enter into a sleep state.

3. The RFID tag as claimed in claim 1, wherein the data receiving microchip is an electrically erasable programmable read-only memory (EEPROM) including a RF port and an inter-integrated circuit (I2C) port, the RF port receives the identification code from the RFID tag, and the I2C port is electronically connected to the microcontroller.

4. The RFID tag as claimed in claim 1, wherein the indication circuit includes a buzzer, the microcontroller turns on the buzzer if the inquiry command is identical with the identification code or the predetermined part of the identification code.

5. The RFID tag as claimed in claim 1, wherein the indication circuit includes a lighting component, the microcontroller turns on the lighting component if the inquiry command is identical with the identification code or the predetermined part of the identification code.

6. The RFID tag as claimed in claim 1, wherein the RF circuit feeds the identification code to the RFID reader, and receives an acknowledgement (ACK) command from the RFID reader.

7. The RFID tag as claimed in claim 1, further comprising a reset button that generates a command when the reset button is actuated, and the microcontroller receives the command to power off the RFID tag.

8. The RFID tag as claimed in claim 7, further comprising a body, wherein the signal receiving circuit, the microcontroller, the RF circuit, the indication circuit, and the reset button are all integrated on the body.

9. The RFID tag as claimed in claim 1, wherein the identification code is generated according to an express serial number of the article.

10. A method for searching for an article, the method comprising:
receiving an identification code from a radio frequency identification (RFID) reader through an RFID tag of the article;
receiving an inquiry command from the RFID reader through the RFID tag after the RFID is attached to the article;
determining whether the inquiry command is identical with the identification code or a predetermined part of the identification code, and turning on an indication circuit of the RFID tag if the inquiry command is identical with the identification code or a predetermined part of the identification code.

11. The method for searching for an article as claimed in claim 10, further comprising controlling the RFID tag to enter into a sleep state if the inquiry command is not identical with the identification code or the predetermined part of the identification code.

12. The method for searching for an article as claimed in claim 10, further comprising generating a command by actuating a reset button of the RFID tag to power off the RFID tag.

13. The method for searching for an article as claimed in claim 10, wherein the step of receiving an identification code from a radio frequency identification (RFID) reader by a RFID tag further comprises:
generating the identification code according to an express serial number of the article;
sending the identification code to a data receiving microchip of the RFID tag; and
transmitting the identification code from the data receiving microchip to a radio frequency (RF) circuit of the RFID tag.

14. The method for searching for an article as claimed in claim 13, further comprising feeding the identification code to the RFID reader, and receiving an acknowledgement (ACK) command from the RFID reader by the RF circuit.
